(19) United States
(12) Patent Application Publication
(10) Pub. No.: US 2015/0135904 A1
(43) Pub. Date: May 21, 2015

(54) DUAL PURPOSE KNIFE SLEEVE

(71) Applicants: Luis Eduardo Salazar Leon, Kirkland, WA (US); Luis Jose Salazar Gago, Kirkland, WA (US)

(72) Inventors: Luis Eduardo Salazar Leon, Kirkland, WA (US); Luis Jose Salazar Gago, Kirkland, WA (US)

(21) Appl. No.: 14/526,024

(22) Filed: Oct. 28, 2014

Related U.S. Application Data
(60) Provisional application No. 61/904,620, filed on Nov. 15, 2013.

(51) Int. Cl. B24D 15/08; B26B 29/02

(52) U.S. Cl. CPC B24D 15/084; B26B 29/025
USPC 76/82; 451/486; 451/555

(57) ABSTRACT

A knife sheath and sharpener includes a body having opposing first and second sidewalls, a closed bottom, a closed tip portion, an open end portion and an open top portion interconnected to define a knife receiving cavity. A pair of opposing first and second sharpening elements are disposed within the knife receiving cavity. The first sharpening element is pivotally attached to the first sidewall and the second sharpening element is pivotally attached to the second sidewall at a location longitudinally offset from the first sharpening element.

### CROSS-REFERENCE TO RELATED APPLICATIONS

This application claims the benefit of U.S. provisional application Ser. No. 61/904,620 filed Nov. 15, 2013, the disclosure of which is hereby incorporated in its entirety by reference herein.

### TECHNICAL FIELD

The present disclosure relates to knife sleeves having built-in knife sharpening elements.

### BACKGROUND

Knives typically include a handle and a blade having a cutting-edge typically disposed along the bottom of the blade. Knives may be stored in a sheath when not in use to protect the cutting-edge from damage and to prevent the cutting-edge from accidentally harming other objects. Cutting edges require periodic sharpening to prevent the edge from becoming dull from usage. Knife sheaths may include sharpening elements for sharpening the cutting-edge of the blade.

### SUMMARY

According to one embodiment, a knife sheath and sharpener includes a body having first and second cover members forming a closed bottom portion, a closed tip portion, an open end portion and an open top portion interconnected to define a knife receiving interior. Each of the first and second cover members have exterior and interior surfaces. A pair of opposing sharpening elements are disposed within the knife receiving interior. One of the sharpening elements is disposed on the first cover member interior surface proximate the closed bottom portion and the other sharpening elements is disposed on the second cover member interior surface proximate the closed bottom portion.

According to another embodiment, a knife sheath and sharpener includes a body having opposing first and second sidewalls, a closed bottom, a closed tip portion, an open end portion and an open top portion interconnected to define a knife receiving cavity. A pair of opposing first and second sharpening elements are disposed within the knife receiving cavity. The first sharpening element is pivotally attached to the first sidewall and the second sharpening element is pivotally attached to the second sidewall at a location longitudinally offset from the first sharpening element.

### BRIEF DESCRIPTION OF THE DRAWINGS

FIG. 1 illustrates a top view of a knife sheath without a sharpening mechanism.

FIG. 2 illustrates a top view of a portion of the knife sheath including a sharpening mechanism.

FIG. 3 illustrates a front section view of the knife sheath along line 3-3 of FIG. 2.

FIG. 4 illustrates a detail view of a slot and platform adjuster.

FIG. 5 illustrates a side section view of the knife sheath along line 5-5 of FIG. 2.

FIG. 6 illustrates a front section view of the knife sheath as shown in FIG. 3 with the stones rotated to an alternate position.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

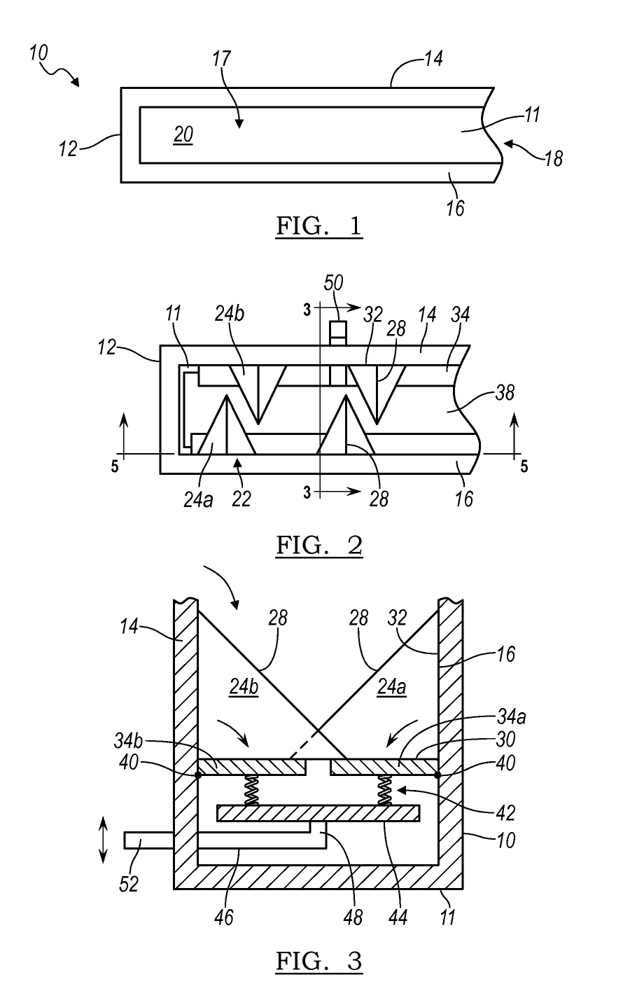

Referring to FIG. 1, a top view of a knife sheath 10 is shown. The knife sheath 10 includes a bottom 11 and opposing first and second sidewalls 14, 16 connected to the bottom 11 and extending upwardly therefrom. The first and second sidewalls 14, 16 and the bottom 11 may be interconnected by a front wall 12 forming a closed tip portion. The knife sheath 10 may have an open top 17 and an open end 18 opposite the tip portion. The open top 17 allows the knife sheath 10 to fit knives of varying size for a one size fits all sheath. The opened end 18 allows knives to be received in and out of the knife sheath 10. The knife sheath 10 may also include an interior 20 defined by the bottom 11, the first and second sidewalls 14, 16 and the front wall 12. Knife sheath materials may include plastic, metal or ceramics. For example, the knife sheath 10 may be injection molded plastic.

In another embodiment, the knife sheath 10 may be formed of a first cover member half and a second cover member half. The first and second cover members are interconnected forming a closed bottom portion and a closed tip portion. The first and second cover members may be joined along a centerline of the bottom portion and the tip portion. The first and second cover members may be joined by glue, snaps or other fastening means. The knife sheath 10 includes an open end portion and an open top portion. The knife sheath 10 includes a knife receiving interior defined by the interior surfaces of the first and second cover members.

Referring to FIG. 2, the knife sheath 10 also includes a knife sharpening mechanism disposed along the bottom 11 of the sheath 10. The knife sharpening mechanism is configured to sharpen knife blades as they are drawn across the sharpening mechanism. The blade may be sharpened by moving the blade into and out of the opened end 18. The knife sharpening mechanism may include a plurality of sharpening element pairs 22. FIG. 2 only illustrates two sharpening element pairs 22, however the present disclosure contemplates providing sharpening element pairs 22 along the entire length of the knife sheath 10. The sharpening element pairs 22 are disposed along the length of the sheath 10 proximate the bottom 11. The sharpening element pairs 22 may be evenly spaced or may have variable spacing relative to each other. Each sharpening pair 22 may include two sharpening stones 24, stone 24A and stone 24B. Sharpening stone 24A and sharpening stone 24B are on opposing sides of the sheath 10. Each sharpening stone 24 may include a base 30 defining a bottom of the stone and a standing surface 32 disposed adjacent to a respective sidewall. Each sharpening stone 24 includes a sharpening edge 28 that connects to the base 30 at a lower end of the sharpening edge 28 and connects to the standing surface 32 at the upper end of the sharpening edge 28. The stone 24A and stone 24B may be longitudinally offset relative to each other along the length of the sheath 10 such that the sharpening edges cross each other forming a “V” shape when viewed though the open end 18. The sharpening edges 28 on each stone 24A, 24B cooperate to engage the blade and sharpen the cutting-edge of the blade as the cutting edge moves across the sharpening stones 24. The sharpening stones 24 may be half pyramids in shape having a triangular base 30 and a triangular standing surface 32. Alternatively, the sharpening stones may be round or square. The angle of the sharpening edge relative to the base 30 may be approximately 55° to 80°, and in other embodiments, 65° to 75°.

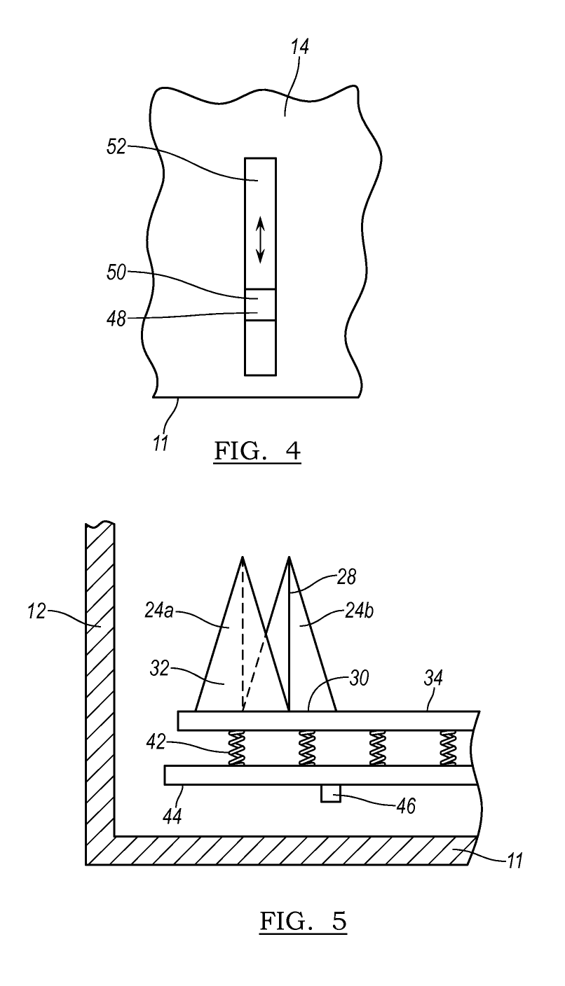

Referring to FIGS. 3, 4 and 5, each stone 24 may be attached to a stone support 34 at the base 30 of the stone. The knife sheath 10 may include two opposing stone supports 34A and 34B running longitudinally along the sheath 10. Each stone 24A may be attached to stone support 34A and each stone 24B may be attached to stone support 34B forming two opposing stone banks. Alternatively, each stone may be attached to its own stone support 34 providing independent movement for each stone 24. The opposing stone supports 34 may be attached to a respective opposing sidewall 14, 16. Each stone support 34 may be pivotally attached to a respective sidewall via a hinge 40. The hinge 40 may be attached between a bottom surface edge of the stone supports 34 and an interior surface of the sidewall. The hinge 40 is ideally attached to the sidewall at the bottom one third of the sidewall. The hinge 40 may be a barrel hinge, a living hinge, a piano hinge, a strap hinge or other suitable type of hinge. Each stone 24 may be fixed relative to their respective stone support 34 and pivot with the stone support 34. Pivoting the stone supports 34 allow the angle of the sharpening edge 28 to be changed to accommodate knives of different shapes and sizes. Each stone supports 34 may be supported by a platform 44. A spring 42 may be disposed between the stone support 34 and the platform 44.

In another embodiment, the springs 42 may be replaced with rigid elements connected between the stone supports 34 and the platform 44. The platform 44 may be vertically adjusted relative to the sidewalls 14, 16 of the knife sheath 10. Adjusting the platform 44 pivots the stone supports 34 and is one mechanism for adjusting the angle of the sharpening edges 28. A platform adjuster 46 may be connected to the platform 44 along the bottom edge of the platform. The platform adjuster 46 may include an arm 48 that projects through one of the sidewalls 14, 16 and includes a handle 50 at a distal end of the arm 48. A user may slide the handle 50 and arm 48 up and down via a slot 52 defined in the sidewall. The handle 50 and the slot 52 may include cooperating teeth and a locking mechanism for locking the platform 44 in a specific vertical position. A release mechanism may be included for releasing the locking mechanism. The release mechanism may be a spring-loaded button.

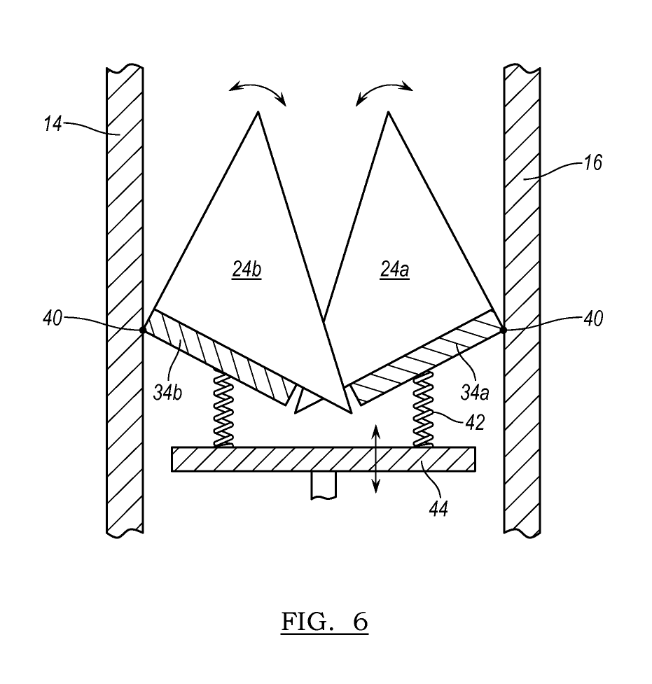

Referring to FIG. 6, the sharpening stones 24 and the stone supports 34 are shown rotated to an alternative position as compared to FIG. 3. Each platform 44 is connected to an interior portion of a respective sidewall via a hinge 40 to allow the platform 44 to rotate relative to the sidewall. This allows the sharpening stones 24 to rotate and adjust the angle of the sharpening edges 28. The sharpening stones 24 can be adjusted coarsely using the platform adjuster 46 to move the platform 44 up-and-down changing the angle of the sharpening edges 28. The sharpening stones 24 can be finely adjusted by compressing the springs 42. The springs 42 will compress slightly when a user applies a force onto the stones 24 and thus the user can finely adjust the sharpening stone edges by modulating the downward force applied to the knife.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A knife sheath and sharpener comprising:
a body having first and second cover members forming a closed bottom portion, a closed tip portion, an open end portion and an open top portion interconnected to define a knife receiving interior, each of the first and second cover members having exterior and interior surfaces; and
a pair of opposing sharpening elements disposed within the knife receiving interior, one of the sharpening elements being disposed on the first cover member interior surface proximate the closed bottom portion and the other of the sharpening elements being disposed on the second cover member interior surface proximate the closed bottom portion.

2. The knife sheath and sharpener of claim 1 wherein each of the sharpening elements includes a sharpening edge for engaging a knife cutting edge to sharpen it when the knife is moved across sharpening edges.

3. The knife sheath and sharpener of claim 2 wherein the sharpening edge is angled outward at a sharpening angle from the cover member in which it is disposed.

4. The knife sheath and sharpener of claim 3 wherein the sharpening angle is in the range of 55 to 80 degrees.

5. The knife sheath and sharpener of claim 1 wherein each of the pair of sharpening element includes a base and standing edge.

6. The knife sheath and sharpener of claim 1 wherein the pair of opposing sharpening elements are offset relative to each other.

7. The knife sheath and sharpener of claim 1 wherein each of the sharpening elements are pyramidal shaped sharpening elements.

8. The knife sheath and sharpener of claim 1, wherein the sharpening elements are equally spaced along the length of the closed bottom portion.

9. A knife sheath and sharpener comprising:
a body including opposing first and second sidewalls, a closed bottom, a closed tip portion, an open end portion and an open top portion interconnected to define a knife receiving cavity; and
a pair of opposing first and second sharpening elements disposed within the knife receiving cavity, the first sharpening element being pivotally attached to the first sidewall and the second sharpening element being pivotally attached to the second sidewall at a location longitudinally offset from the first sharpening element.

10. The knife sheath and sharpener of claim 9 wherein the first sharpening element further includes a first sharpening stone and a first stone support connected to a base of the first sharpening stone, the first stone support being pivotally connected to the first sidewall allowing the first stone to rotate relative to the first sidewall.

11. The knife sheath and sharpener of claim 10 wherein second sharpening element further includes a second sharpening stone and a second stone support connected to a base of the second sharpening stone, the second stone support being pivotally connected to the second sidewall allowing the second stone to rotate relative to the second sidewall.

12. The knife sheath and sharpener of claim 11 further comprising a platform connected to the first stone support and the second stone support, the platform being vertically adjustable relative to the bottom portion to adjust an angle of the first and second sharpening stones.

13. The knife sheath and sharpener of claim 12 wherein the platform is connected to the first stone support and the second stone support via a pair of springs to allow fine movement of the pair of opposing first and second sharpening elements.

14. The knife sheath and sharpener of claim 13 further comprising a vertical slot defined in one of the first and second sidewalls and a platform adjuster connected to the platform, wherein a portion of the platform adjuster is received though the vertical slot allowing a user to vertically adjust the platform.

15. The knife sheath and sharpener of claim 11 wherein each of the first and second sharpening stones are pyramidal shaped sharpening stones.

16. The knife sheath and sharpener of claim 11 wherein each of the first and second sharpening stones further includes a standing surface extending upwardly from the base and a sharpening edge extending between a top of the standing surface and the base.

17. The knife sheath and sharpener of claim 16 wherein the sharpening edge is angled outward at a sharpening angle from the standing surface.

18. The knife sheath and sharpener of claim 17 wherein the sharpening angle is in the range of 55 to 80 degrees.

19. The knife sheath and sharpener of claim 11 wherein the first stone includes a first sharpening edge and the second stone includes a second sharpening edge, the first and second sharpening edges cooperating to define a “V” shaped channel for receiving and sharpen a cutting edge of a knife.

20. The knife sheath and sharpener of claim 9 wherein a portion of the first sharpening element overlaps with a portion of the second sharpening element.
